(19) United States
(12) Patent Application Publication
(10) Pub. No.: US 2025/0229288 A1
(43) Pub. Date: Jul. 17, 2025

(54) APPARATUS FOR DISPENSING ADHESIVE AND METHODS OF DISPENSING ADHESIVE

(71) Applicant: 3M INNOVATIVE PROPERTIES COMPANY, St. Paul, MN (US)

(72) Inventors: Chase M. O'Brien, Roseville, MN (US); Steven E. Turch, Blaine, MN (US)

(21) Appl. No.: 18/718,652

(22) PCT Filed: Dec. 13, 2022
(86) PCT No.: PCT/IB2022/062130

§ 371 Date: Jun. 11, 2024

Related U.S. Application Data
(60) Provisional application No. 63/265,679, filed on Dec. 17, 2021.
(60) Provisional application No. 63/266,495, filed on Jan. 6, 2022.

(51) Int. Cl. B05C 5/00; B05C 5/02; B05C 13/02; F16L 13/11

(52) U.S. Cl. CPC B05C 5/002; B05C 5/0241; B05C 13/02; F16L 13/11

(57) ABSTRACT

The present disclosure provides an apparatus (2, 4) for dispensing adhesive. In one embodiment, the apparatus comprises: a housing body (12) including a cavity and an aperture (22), wherein the housing body includes a front plate (20) having an angled internal surface (24); an internal member having an angled surface; a channel (226) for adhesive positioned to extrude adhesive between the angled internal surface and the angled surface of the internal member onto the outer surface of the selected male pipe.

### GOVERNMENT SUPPORT CLAUSE

This invention was made with government support under Subcontract No. 4000153415 to Prime Contract No. DE-AC05-OR22725 awarded by the Department of Energy (DOE). The government has certain rights in the invention.

### BACKGROUND

Conventionally, in the heating, ventilation and air conditioning (HVAC) heat exchanger industry, pipes are joined together using a process called brazing. Brazing is a pipe bonding process where metal objects are joined together by melting and flowing a filler metal into the joint. In most instances, the joints being joined are made of similar metals (i.e., copper/copper) therefore galvanic corrosion between joints is not a concern. However, in certain specialty applications, the two metal surfaces being joined are made up of dissimilar metals, and galvanic corrosion can become an issue leading to premature joint failure or compromise. Conventionally, these dissimilar metal joints are brazed together using the typical process, followed by a postprocessing step where a section of heat-shrink tubing is placed over the brazed joint and heated (to induce shrinkage) to form a watertight seal over the joint. The heat shrink tubing serves to eliminate or diminish galvanic corrosion between the two metals due to water bridging the gap between metal surfaces.

One major drawback of the current process above is that it involves multiple steps. The joint is first brazed, and then in a second step the heat shrink tubing is applied. This process is time consuming and requires individual heating of each individual joint in a complex assembly to induce shrinkage of the tubing.

Accordingly, what is needed in the industry is an easier, less time-consuming process or method of bonding two similar or dissimilar metals together that will both provide a strong joint and eliminate or minimize galvanic corrosion at the interface of the metals. One way in which to provide such process is to use a structural adhesive for bonding the two similar or dissimilar metals together. Exemplary adhesives are taught in U.S. Patent Application, Ser. No. 63/127,432, titled “Methods of Bonding Metal Articles and Articles Formed Thereby, Docket No. 83332US002, and U.S. Patent Application, Ser. No. 63/127,438, titled “Methods of Bonding Copper and Articles Formed Thereby,” Docket No. 83623US002, both of which are hereby incorporated by reference. However, improvements in nozzles, applicators, and apparatuses for delivering such structural adhesives to the metals to be bonded will further assist the industry by providing easier, less time-consuming processes or methods.

### SUMMARY OF THE DISCLOSURE

The present disclosure provides apparatuses and method for dispensing adhesive. In one embodiment, the apparatus comprises: a housing body including a cavity; a housing front plate including an aperture sized to accommodate an outer surface of a selected male pipe, wherein housing front plate includes an angled surface; a channel for adhesive positioned to extrude adhesive between the angled surface and the outer surface of the selected male pipe.

In another embodiment, the present disclosure provides an alternative apparatus for dispensing adhesive, comprising: a housing body including a cavity; a housing front plate including an aperture sized to accommodate an outer surface of a selected male pipe, wherein the housing front plate includes an angled surface; a channel for adhesive positioned to extrude adhesive between the angled surface and the outer surface of the selected male pipe; a location pin mounted inside the cavity, wherein the location pin is sized to accommodate an inner surface of the selected male pipe.

In yet another embodiment, the present disclosure provides an apparatus for dispensing adhesive. This an apparatus for dispensing adhesive, comprises: a housing body including a cavity and an aperture, wherein the housing body includes an angled internal surface; a pipe ejector member mounted inside the cavity, wherein the pipe ejector member includes an angled surface; and wherein the pipe ejector member includes a depression for receiving an end of a selected male pipe; and a channel for adhesive positioned to extrude adhesive between the angled internal surface and the outer surface of the selected male pipe.

The present disclosure also provides methods of applying adhesive. In one embodiment, the method comprises: providing an apparatus described above; providing an adhesive to flow through the apparatus; providing a male pipe and a female pipe, wherein the male pipe comprises a first metal, and wherein the female pipe comprising a second metal; applying an adhesive composition to a male pipe; inserting at least a portion of the adhesive composition and the male pipe into the female pipe thereby forming an interface between the male pipe and the female pipe; and curing the adhesive composition to form an adhesive bond between the male pipe and the female pipe, wherein the cured adhesive composition limits corrosion of at least a portion of the male pipe, the female pipe, or both.

The phrase “adhesive composition” refers to a composition, which on its own or in combination with another composition may, once cured, adhere two materials together, thereby forming an adhesive bond. In some instances, an adhesive composition in combination with another adhesive composition can form an adhesive bond once the adhesive compositions are cured. In some such instances, the adhesive compositions may be the same, some such adhesive compositions can be referred to as one part or one component (1K) adhesives. Illustrative 1K adhesives include, for example 1K epoxy adhesives, 1K acrylate adhesives, 1K urethane adhesives, as well as hybrids of the above chemistries. In some instances, two adhesive compositions components may be different, some such adhesive compositions can be referred to as two part or two component (2K) adhesives. 2K adhesives are generally made up of a Resin (Part A) and a Hardener (Part B). Generally, these materials are mixed prior to application of the materials onto the substrate surface. After the two parts are mixed, curing can occur, not necessarily immediately and not necessarily without an outside influence (e.g., heat, energy, etc.). Illustrative 2K adhesives include, for example, 2K epoxy adhesives, 2K acrylate adhesives, and 2K urethane adhesives as well as hybrids of the above chemistries. It should be noted that there is no additional inference to be made from referring to a composition as first or second, it is merely for the sake of convenience and clarity.

The phrase “adhesive bond” is a result of curing the first and/or first and second precursor adhesive compositions. The adhesive bond in this case serves to adhere the joining region of the first article to the joining region of the second article.

The phrase “female article” refers to an article that has a hollow generally cylindrical body with an internal diameter. A female article can be a pipe with a larger starting diameter than the “male article” or be accomplished by flaring/widening the end of a smaller diameter pipe (i.e., flaring a “male article” so that it becomes a larger diameter member that can serve as a “female element”).

The phrase “male article” refers to an article that has a hollow generally cylindrical body that fits within the female article and has an external diameter slightly less than the internal diameter of the female article. A male article can be a pipe with a smaller starting diameter than the “female article.” Generally, the difference between the outer diameter of the male article and the inner diameter of the female article is on the order of 2-50 thousandths of an inch, most typically 5-20 thousandths of an inch.

The above summary of the present disclosure is not intended to describe each disclosed embodiment or every implementation of the present disclosure. The description that follows more particularly exemplifies illustrative embodiments. In several places throughout the application, guidance is provided through lists of examples, which examples may be used in various combinations. In each instance, the recited list serves only as a representative group and should not be interpreted as an exclusive list. Thus, the scope of the present disclosure should not be limited to the specific illustrative structures described herein, but rather extends at least to the structures described by the language of the claims, and the equivalents of those structures. Any of the elements that are positively recited in this specification as alternatives may be explicitly included in the claims or excluded from the claims, in any combination as desired. Although various theories and possible mechanisms may have been discussed herein, in no event should such discussions serve to limit the claimable subject matter.

### BRIEF DESCRIPTION OF THE FIGURES

FIGS. 1A-1D are illustrating example steps in the process of adhesively bonding a female and male article, where the adhesive was applied by the apparatus of the present invention;

FIG. 2A is a perspective view of an exemplary apparatus of the present invention;

FIG. 2B is a cross-sectional view of the apparatus of FIG. 2A taken along line A-A;

FIG. 2C is a perspective view of another exemplary apparatus of the present invention;

FIG. 2D is a cross-sectional view of the apparatus of FIG. 2B taken along line B-B;

FIG. 2E is an enlarged view of the apparatus of FIGS. 2A and 2B;

FIGS. 3A-3F are illustrating example steps in the process of applying adhesive to a male article, where the adhesive was applied by the apparatus of the present invention;

FIGS. 4 and 5 are cross-sectional views of yet another exemplary apparatus of the present invention; and

FIG. 6 is a cross-sectional views of another exemplary apparatus of the present invention.

### DETAILED DESCRIPTION OF ILLUSTRATIVE EMBODIMENTS

The present disclosure provides inventive apparatuses for applying adhesive that is useful for joining two articles together, specifically joining a female article and a male article. This process of joining the two articles is the equivalent of both the brazing and heat shrink tubing application steps are combined into a single operation. In this invention, the adhesive is applied by the apparatus onto the outside of the male pipe in a way that, when inserted into the female joint, it creates a sealed joint that irreversibly joins the two pipes together upon curing. At the same time, the adhesive is further applied onto the surface of at least the male end of the pipe along the length in order to act as a coating that inhibits galvanic corrosion. By following this process, the need for a heat shrink tubing to be applied to the system is eliminated. In certain special applications, the male end of the pipe only having enough adhesive applied to its surface to ensure formation of a sealed joint upon insertion into the female joint and curing may have additional adhesive further applied.

The methods disclosed herein are methods of forming a bond using the inventive apparatuses of the present invention. The methods include a step of applying an adhesive composition to some portion of the end of at least the male article using one of the inventive apparatuses; inserting the male element into the female article; and curing the adhesive composition. At least some portion of an external surface of the male article, the female article, or both can also have adhesive composition applied thereto. At least the external interface where both the male article and the female article are exposed to the atmosphere, referred to herein as an external interface, is coated with adhesive. The adhesive on the external interface does not necessarily assist in adhering the two articles together, but does prevent or at least decrease the amount of galvanic corrosion that can happen at the interface of the two dissimilar metals.

The apparatuses of the present invention provide at least the following benefits. First, the apparatus is specially designed to dispense a precise uniform thickness or tapered annular-shaped layer of adhesive onto the outer diameter or external surface of a tubular body, such as a pipe, along a portion of this axial length. Second, the apparatus will apply the adhesive coating in a sleeve like configuration, of predetermined length and tapered shape, and terminates as close as possible to the planar end of the tubular body. Both aspects assist in providing an adhesive configuration that bonds the outer diameter of a tubular body, such as a male article, to the inner diameter of another tubular body, such as a female article. The apparatuses of the present invention also include the capability to extend the coating length of the adhesive to provide galvanic corrosion protection at the junction region. For instance, in this case, the adhesive itself may act as an insulator to prevent the corrosion that may occur when dissimilar metals are joined. Third, the apparatuses of the present invention offer better control and minimization of adhesive stringing between the apparatus and the tubular body, thus producing a clearer adhesive separation. Adhesive stringing (or sometimes known as adhesive tailing) has been a known problem in the prior art to optimized adhesive dispensing. Adhesive stringing occurs when adhesive is left behind either on the apparatus and/or pulled into a string when the adhesive dispensing device is retracted from the adhesive that has been previously deposited onto a substrate. Adhesive stringing can bring about an undesirable consequence of fouling the delivery device's die lip, and thus compromising its future performance. For instance, with adhesive stringing, the adhesive may fall back into the aperture of the apparatus where the pipe is inserted, and thereafter, when the next pipe is inserted into the apparatus, adhesive can inadvertently adhere to the inner diameter of the pipe. Also undesirable with stringing, adhesive can find its way onto the planer end of the tubular body, and as a result, the adhesive will likely be inside the interior of the tubular bodies after they have been bonded together, interfering with the flow of materials through the joined tubular bodies. Fourth, the apparatus of the present invention provide better control and repeatability in applying adhesive to outer diameters of tubular bodies, which significantly reduces time required to bond tubing while also providing a more consistent dispensing process. Last, the apparatuses of the present invention allow unskilled laborers to create adhesive bonds between tubular bodies easily in place of skilled laborers typically needed to braze the tubular bodies, as discussed above.

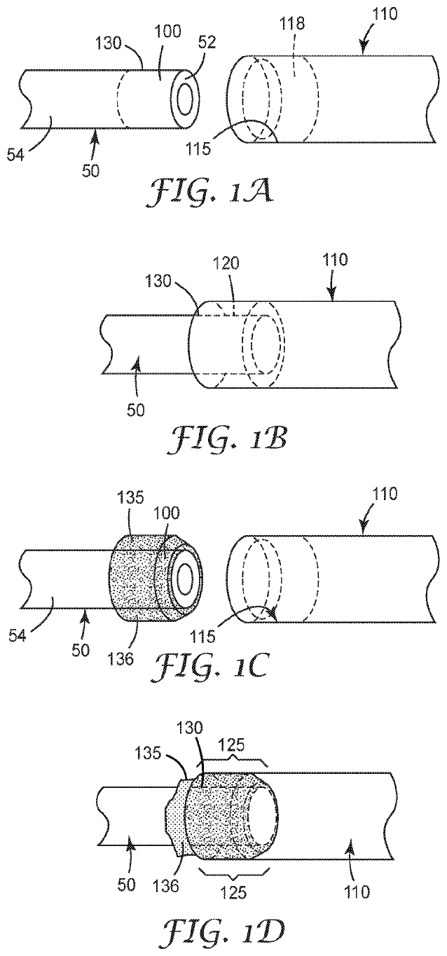

FIGS. 1A-1D help illustrate the process of joining two pipes after the use of the apparatus of the present invention (described in more detail below) to apply a sleeve of adhesive 136. FIG. 1A illustrates a first article 50. The first article 50 is generally configured as a male article 50, has an external surface 130 and is made of or includes a first metal. The male article 50 includes a joining region 100. At least the joining region 100 of the male article 50 is made of a first metal. FIG. 1A also shows a second article 110. The second article 110 is generally configured as a female article 110, as an internal surface 115, and is made of or includes a second metal. The female article 110 also includes a joining region 118. At least the joining region 118 of the female article 110 is made of a second metal. In one embodiment, the first metal and the second metal are selected from copper (Cu), aluminum (Al), stainless steel, or brass. In a particular embodiment, the first metal and the second metal are copper (Cu) and aluminum (Al) respectively.

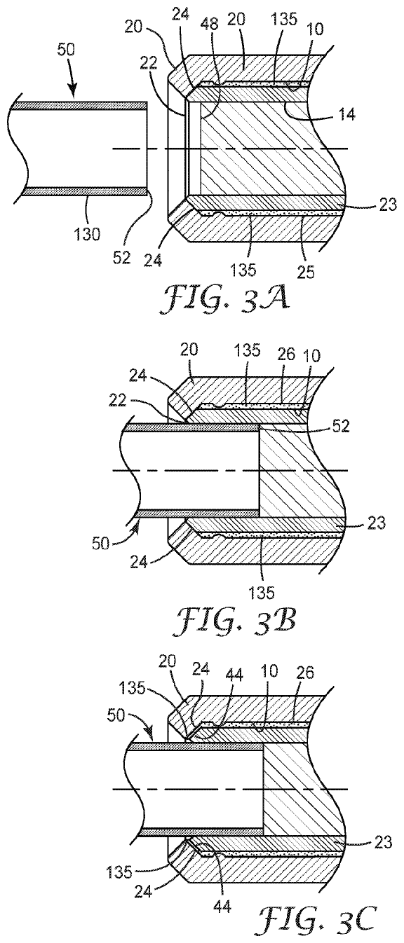

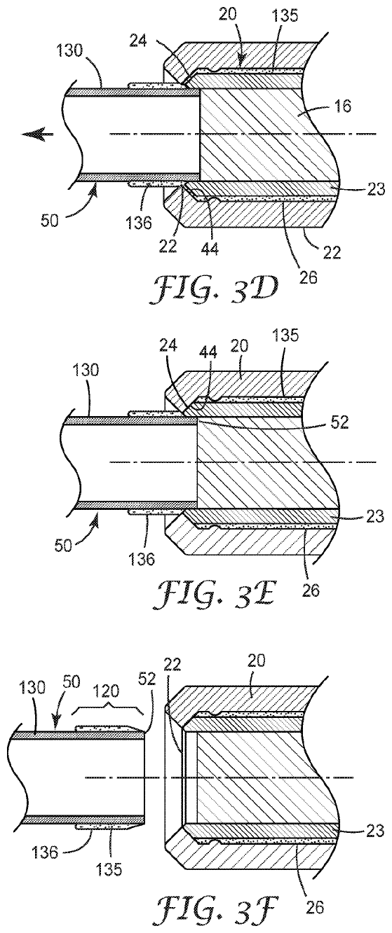

When the male article 50 is inserted into the female article, the overlap of the joining area between the internal surface 115 of the female article 115 and the external surface 130 of the male article 50 is joining region 120, as illustrated in FIG. 1B. As illustrated in FIG. 1C, a layer of adhesive 135 in the form of a tapered sleeve 136 is applied to the external surface 130 of the male article 50 by the apparatus of the present invention. The application of the adhesive 135 to the male pipe 50 is discussed in more detail below in reference to FIGS. 3A-3F. The adhesive 135 is shown in with a portion in a uniform thickness and a portion closest to the planar end of the pipe 50 in a fully tapered arrangement.

FIG. 1D illustrates how the sleeve of adhesive 136 bonds the female pipe 110 to the male pipe 50. It is advantageous to have the sleeve-like coating 136 fully tapered because the tapered coating allows the adhesive to get more easily into the overlap section of the joint between the male and female pipes in their respective joining regions 100, 115 more easily. If the adhesive coating isn't tapered, then it is possible that a significant amount of adhesive can potentially be scraped off or pushed out of the overlap of the joining regions, which typically happens in prior art adhesive applicators. Additionally, due to the nature of the adhesive, as some adhesive is scraped, more adhesive is often pulled with it reducing the amount in the joint.

One example range of thickness of the adhesive layer on the external surface 54 of the male pipe 50 as applied by the apparatus of the present invention (discussed below) is 0.125-0.1875 inches measured axially regardless of the pipe size. The length of the adhesive is dependent on the pipe size, but typically ranges from 0.25 to 0.75 inches. Together, these ranges create optimum sleeves of adhesive produced by the apparatuses of the present invention. That being said, the type of adhesive 135 may be applied by the apparatus of the present invention at any selected rate to obtain a desired thickness and length. Ideally, the sleeve-like coating of adhesive 136 is substantially not, and preferably not at all on the planer end 138 of the male pipe, after the apparatus applies the adhesive 135. In addition, the sleeve-like coating of adhesive 136 is applied in a tapered manner, such that the axial diameter of the thickness may taper between 0.125-0.1875 inches.

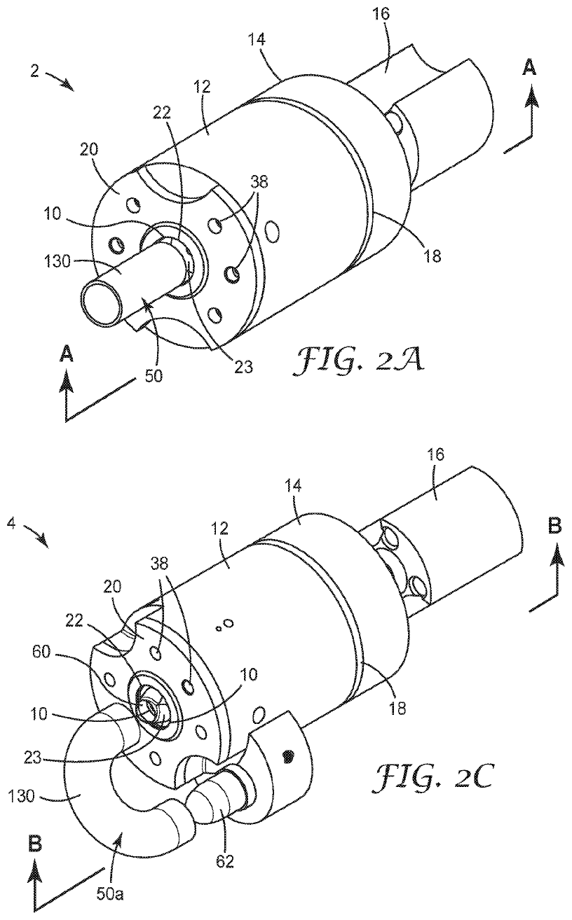

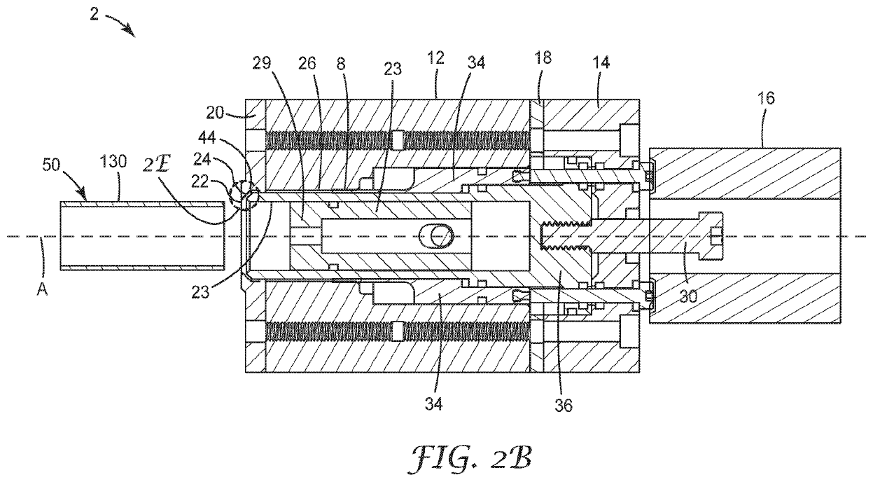

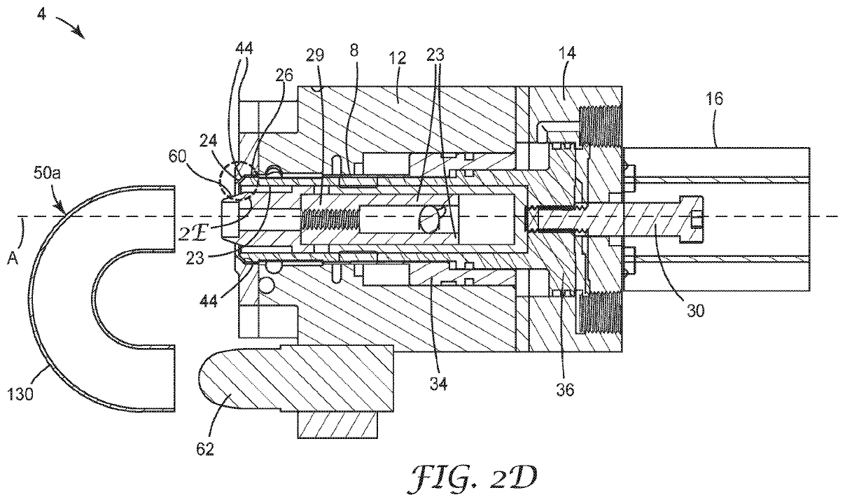

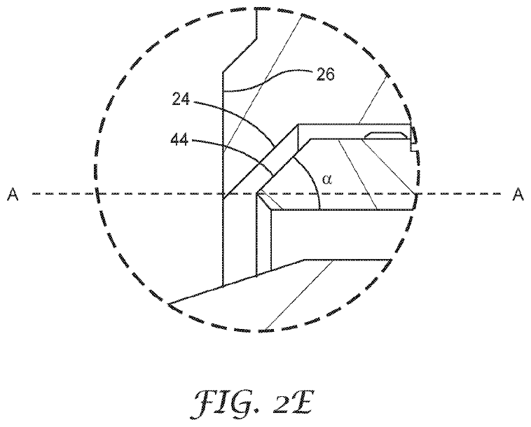

FIG. 2A illustrates one exemplary embodiment of apparatus 2 for applying adhesive of the present invention. Apparatus 2 includes a housing body 12, a housing front plate 20 mounted to the front of the housing body 12, and a housing rear plate 14 mounted to the rear of the housing body 12 (opposite the front plate 20). The front plate 20 and rear plate 14 are mounted to the housing by any suitable means in the art, for example by bolts or with through holes and dowel pins. The housing rear plate 14 and housing 12 may include an optional spacer plate 18 located between the rear plate 14 and the housing 12. The apparatus 2 includes a push block 16, which is useful for moving the pipe ejector 23 mounted inside the cavity 10. Apparatus 2 includes an axis A which runs the length of the apparatus 2 from the center of the aperture 22 to the center of the push block 16.

FIG. 2B is useful for illustrating other portions of apparatus 2. The housing front plate 20 includes an aperture 22 leading into a cavity 10. The aperture is sized to accommodate an outer surface of a male pipe 50, as illustrated in the Figure. The housing front plate 20 includes an angled surface 24. The pipe ejector 23 also includes an angled surface 44. A channel 26 is formed between the cavity 10 and the pipe ejector 23. The apparatus 2 is designed so that adhesive will flow in the channel 26 formed in the space between the angled surface 44 of the pipe ejector and angled surface 24 of the housing front plate 20 to be dispensed out the aperture 22. Preferred angles for the angled surfaces 24, 44 are discussed below in reference to FIG. 2E. The apparatus 2 includes an extrusion sleeve 34 and an shut off sleeve 36. Bolt 30 is useful for connecting the push block 16 to a shut off sleeve 36.

FIG. 2C illustrates one exemplary embodiment of apparatus 4 for applying adhesive of the present invention. Apparatus 4 is useful for applying adhesive to a U-bend male pipe 50a. Apparatus 4 is very similar to apparatus 2 illustrated in FIGS. 2A and 2B, however it includes an on center location pin 60 mounted on the end of the pipe ejector 23 and an off center location pin 62 mounted to the side of the housing 12. The location pins 60, 62 are useful for correctly inserting one end of the U-bend pipe 50a in the aperture 22 to receive adhesive on the one end by the apparatus 4 and to stabilize the other end of the pipe 50a by connecting it with the off center location pin 62. After the adhesive is applied on the one end, the pipe 50a may be rotated 180 degrees to insert the opposite end of the U-bend pipe 50a into the aperture 22 to likewise received adhesive by the apparatus 4. Apparatus 4 is configured in this way to efficiently and precisely apply adhesive to U-bend type pipes 50a.

Apparatus 4 includes a housing body 12, a housing front plate 20 mounted to the front of the housing body 12, and a housing rear plate 14 mounted to the rear of the housing body 12 (opposite the front plate 20). The front plate 20 and rear plate 14 are mounted to the housing by any suitable means in the art, for example by bolts or with through holes and dowel pins. The housing rear plate 14 and housing 12 may include an optional spacer plate 18 located between the rear plate 14 and the housing 12. The apparatus 4 includes a push block 16, which is useful for moving the pipe ejector 23 mounted inside the cavity 10. Apparatus 4 includes an axis B which runs the length of the apparatus 4 from the center of the aperture 22 to the center of the push block 16.

FIG. 2D is useful for illustrating other portions of apparatus 4. The housing front plate 20 includes an aperture 22 leading into a cavity 10. The aperture is sized to accommodate an outer surface of a male pipe 50, as illustrated in the Figure. The housing front plate 20 includes an angled surface 24. The pipe ejector 23 also includes an angled surface 44. In an alternative embodiment, not shown, the on center location pin 60 on the pipe ejector 23 could include the angled surfaced 44. A channel 26 is formed between the cavity 10 and the pipe ejector 23. The apparatus 4 is designed so that adhesive will flow in the channel 26 formed in the space between the angled surface 44 of the pipe ejector and angled surface 24 of the housing front plate 20 to be dispensed out the aperture 22. Preferred angles for the angled surfaces 24, 44 are discussed below in reference to FIG. 2E. The apparatus 4 includes an extrusion sleeve 34 and an shut off sleeve 36. Bolt 30 is useful for connecting the push block 16 to a shut off sleeve 36.

FIG. 2E is a convenient way to illustrate preferred angles for the angled surfaces 24, 44. Axis A or Axis B, as illustrated in FIGS. 2B and 2D in apparatus 2, 4 respectively, are useful for measuring the angle α of the angled surfaces 24, 44. The angled surfaces 24, 44 may be configured at an angle α of between 5 and 85 degrees relative to the axis A or B, in one embodiment. In another embodiment, the angled surfaces 24, 44 may be configured at an angle α of between 30 and 75 degrees relative to the axis A, preferably, or more preferably at an angle α of between 35 and 55 degrees relative to the axis A or B. The angled surfaces 22, 24 are preferably arranged at an angle to axis A or axis B, like they would be to the length of a male pipe, so that adhesive is dispensed through the channel in a sleeve-like coating. This inventive arrangement is in contrast to most prior art devices where adhesive is dispensed through orifices typically perpendicular to the length of male pipe, and most often the adhesive then tends to flow down into the opening of the adhesive or applicator and causes significant fouling of the adhesive applicator.

FIGS. 3A-3F are convenient for schematically illustrating the application of adhesive 135 onto the external surface 130 of a male article, such as a tubular body or male pipe 50 by use of any of the apparatuses taught herein. First, the male pipe 50 is selected having an outer diameter that fits well within the diameter of the aperture 22, taking into account the expectation of the width of sleeve 136 of adhesive 135 to be applied to the outer diameter. This is illustrated in FIG. 3A. As illustrated in FIG. 3B, the planar end 52 of the male pipe 50 is inserted into the aperture 22 of the apparatus. The adhesive 135 then flows through the channel 26 created between the pipe ejector 23 and the cavity 10. From there, the adhesive 135 will flow out of between the angled surface 24 on the housing front plate 20 and the angled surface 44 on the pipe ejector 23 and be applied to the outer diameter of the male pipe 50, thus creating a sleeve of adhesive 136 on the outside of the male pipe 50. As the adhesive 135 is being applied, the male pipe 50 moves out of the apparatus in the opposite direction in which it was inserted into the aperture 22 of the apparatus. Specifically, the male pipe 50 is pushed out or withdrawn from the apparatus by the pipe ejector 23 in a controlled linear movement to apply the sleeve-like coating 136 of adhesive 135 with a uniform thickness, as illustrated in FIG. 3D. Just prior to the planar end 52 of the male pipe 50 exiting or withdrawing from aperture 22 of the housing front plate 20, the adhesive 135 stops flowing out of the annularly spaced channel 26. The movement of the male pipe 50 is determined at a rate in advance so as to apply the sleeve of adhesive 136 in a uniform thickness around the external surface 130 of the male pipe 50. In one embodiment, the adhesive 135 may be in a sleeve-like coating of adhesive is in a uniform shape axially and is substantially uniform in thickness. In a preferred embodiment, the sleeve-like coating 136 may be tapered just near the planar end 138 of the male pipe 50. Alternatively, the adhesive may be in a fully tapered arrangement, where it is thickest at one end of the sleeve of adhesive and narrowest at the opposite end of the sleeve of adhesive closest to planar end of the pipe. The angled geometry of the angled surface 24 of the housing plate 20 and the angled surface 44 of the pipe ejector 23 of the inventive apparatus assists in tapering the adhesive. The apparatus first begins to apply the adhesive 135 before the pipe 50 is moved. The adhesive continues to be applied as the pipe 50 moves relative to the apparatus. Then, the adhesive flow is shut off by the angled surface 44 of the pipe ejector 23 contacting the angled surface 24 of housing plate 20. Then, as the pipe 50 exits the apparatus and due to the internal cohesive of the adhesive to pull itself toward the end of the pipe 50, resulting in an tapered sleeve of adhesive 136 near the first planar end 52 of the pipe 50. It is advantageous to have the sleeve-like coating 136 tapered because the tapered coating allows the adhesive to get more easily into the overlap section of the joint between the male and female pipes in their respective joining regions 100, 118 more easily. This aspect is illustrated in FIGS. 1A-1D. If the adhesive coating isn't tapered, then it is possible that a significant amount of adhesive can potentially be scraped off or pushed out of the overlap of the joining regions, which typically happens in prior art adhesive applicators. Additionally, due to the nature of the adhesive, as some adhesive is scraped, more adhesive is often pulled with it reducing the amount in the joint.

In addition, dispensing of the adhesive 135 is stopped just prior to removing the pipe 50 from the aperture 22. Typically approximately 0.01″ before the tubing end reached the dispensing portion of the apparatus allowing the adhesive that has been dispensed to be pulled to the end of the tubing.

One example range of thickness of the adhesive layer on the external surface 130 of the male pipe as applied by the apparatus of the present invention is 0.125-0.1875 inches measured axially regardless of the pipe size. The length of the adhesive is dependent on the pipe size, but typically ranges from 0.25 to 0.75 inches. Together, these ranges create optimum sleeves of adhesive produced by the apparatus of the present invention. That being said, the type of adhesive 135 may be applied at any selected rate to obtain a desired thickness and length. Ideally, the sleeve-like coating of adhesive 136 is substantially not, and preferably not at all on the planer end 52 of the male pipe 50, after the apparatus applies the adhesive 135. In addition, the sleeve-like coating of adhesive 136 is applied in a tapered manner, such that the axial diameter of the thickness may taper between 0.125-0.1875 inches.

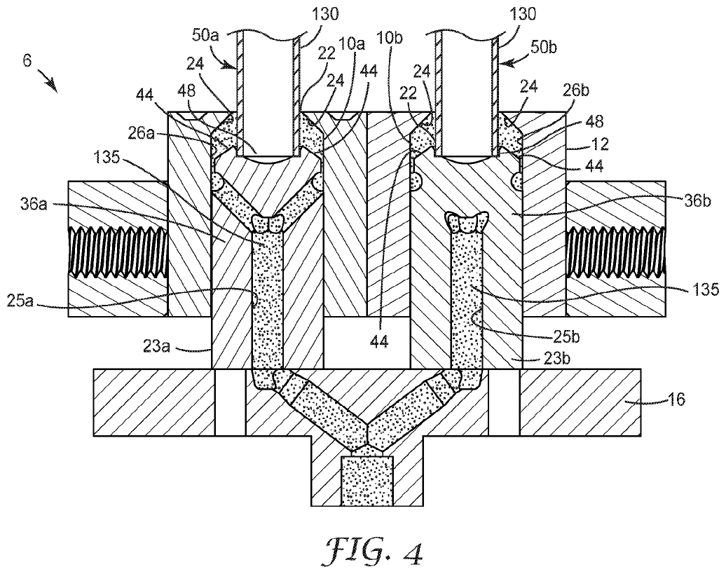

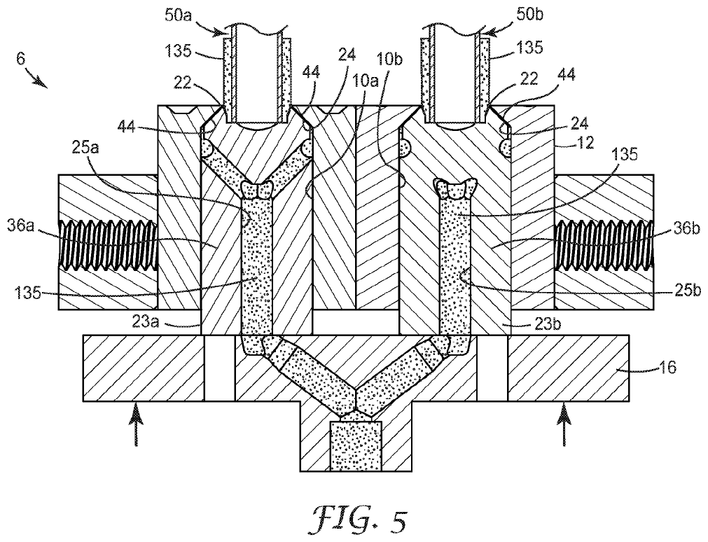

FIGS. 4 and 5 illustrate another embodiment of the apparatus 6 for applying adhesive of the present invention, as it moves between a first position, illustrated in FIG. 4, and a second position, illustrated in FIG. 5. Apparatus 8 is very similar to apparatus 2 and apparatus 4, except that it does not have a housing front plate and is configured to apply adhesive 135 to two male pipes, 50a, 50b at the same time.

Apparatus 2 includes a housing body 12 having two cavities 10a, 10b and a push block 16, which is useful for moving the pipe ejectors 23a, 23b mounted inside the cavities 10a, 10b respectively. Adhesive 135 flows through internal channels 25a, 25b into channels 26a, 26b and out apertures 22. Each pipe ejector 23a, 23b has a sized depression 48 for receiving male pipes 50a, 50b respectively.

In contrast to apparatus 2, 4 discussed above, the apparatus 6 includes an angled surface 24 in each of the cavities 10a, 10b. Similar to apparatus 2, 4, each pipe ejector 23a, 23b includes an angled surface 44. Channel 26a, 26b are formed between the cavity 10 and each pipe ejector 23a, 23b. The apparatus 6 is designed so that adhesive will flow in the channel 26a, 26b formed in the space between the angled surfaces 44 of the pipe ejectors 23a, 23b and angled surfaces 24 of the cavity 10 of the housing 12 to be dispensed out the respective apertures 22. Preferred angles for the angled surfaces 24, 44 are discussed above in reference to FIG. 2E.

FIG. 5 illustrates when the adhesive 135 is shut off from the apparatus 6 when the angled surfaces 44 of the pipe ejectors 23a, 23b contact the angled surfaces 24 of the cavities 10a, 10b of the housing 12, respectively. Also in this position, the male pipes 50a, 50b have been moved externally from the apparatus 6, both having a sleeve of adhesive 135 on the external surface of the pipes 50a, 50b.

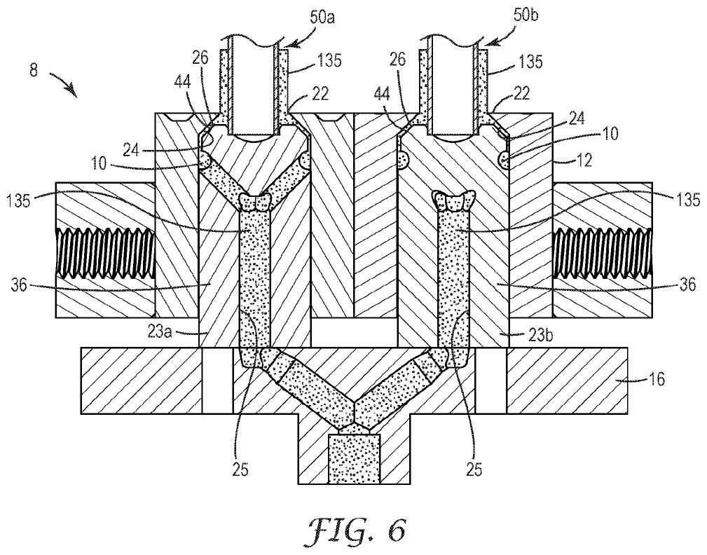

FIG. 6 illustrates yet another apparatus 8 which is very similar to apparatuses 2, 4, 6, except it does not require movement of the pipe ejectors to apply the adhesive 135 to the male pipes 50a, 50b. Apparatus 8 includes a housing body 12 having two cavities 10a, 10b and a push block 16 connected to the pipe ejectors 23a, 23b mounted inside the cavities 10a, 10b respectively. Adhesive 135 flows through internal channels 25a, 25b into channels 26a, 26b and out apertures 22. Each pipe ejector 23a, 23b has a sized depression 48 for receiving male pipes 50a, 50b respectively.

Similar to apparatus 6 discussed above, the apparatus 8 includes an angled surface 24 in each of the cavities 10a, 10b. Similar to apparatus 2, 4, each pipe ejector 23a, 23b includes an angled surface 44. Channel 26a, 26b are formed between the cavity 10 and each pipe ejector 23a, 23b. The apparatus 8 is designed so that adhesive will flow in the channel 26a, 26b formed in the space between the angled surfaces 44 of the pipe ejectors 23a, 23b and angled surfaces 24 of the cavity 10 of the housing 12 to be dispensed out the respective apertures 22. Preferred angles for the angled surfaces 24, 44 are discussed above in reference to FIG. 2E.

The apparatuses discussed herein are especially useful for dispensing structural adhesive compositions. The methods disclosed herein are methods of forming a bond between two copper substrates and/or a copper substrate and a substrate of another metal, such as two pipes. The methods include a step of applying a structural adhesive composition to at least a portion of at least one copper substrate. The structural adhesive composition contains an adhesion promoter, wherein adhesion promoter is a compound of formula I,

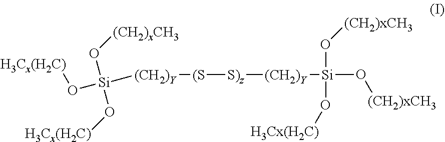

wherein x is an integer from 1 to 4, y is an integer from 2 to 6, and z is an integer from 1 to 6; contacting the portion of the at least one substrate that has the structural adhesive composition applied thereto with a second substrate; and curing the structural adhesive composition to bond the two substrates together, wherein the adhesion promoter is applied within the structural adhesive composition. Once cured, the adhesive composition that forms the adhesive region forms an adhesive bond. Curing the adhesive composition(s) can be accomplished by applying heat to the adhesive compositions, such as via the application of certain wavelengths of energy (i.e., UV triggering of the adhesive), or IR irradiation of the pipe to heat the substrate, or induction curing. The particular method of curing chosen can be based at least in part on the particular adhesive composition(s) being utilized or the substrates being used.

Articles formed using such methods are also disclosed herein. Disclosed articles can include at least two substrates, at least one of which is copper; a structural adhesive composition which contains an adhesion promoter, wherein adhesion promoter is a compound of formula I,

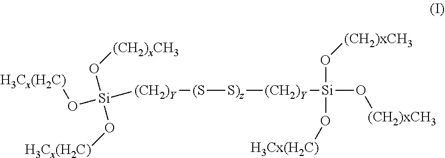

wherein x is an integer from 1 to 4, y is an integer from 2 to 6, and z is an integer from 1 to 6; and the structural adhesive is positioned at least between the two substrates.

In some methods, initial steps can include applying an adhesive composition to at least the joining region of the first article or the male element. In some such embodiments, the adhesive composition can be a 2K epoxy, 2K acrylic, or 2K urethane. In some such embodiments, the adhesive composition can be a 1 part (1K) epoxy adhesives, 1K acrylic adhesives, or 1K urethane.

Generally, adhesive compositions that can be used herein are structural adhesives. Structural adhesives may be divided into two broad categories: one-part adhesives and two-part adhesives. With a one-part adhesive, a single composition comprises all the materials necessary to obtain a final cured adhesive. In the case of thermally cured epoxies, these materials are typically applied to the substrates to be bonded and exposed to elevated temperatures (e.g., temperatures greater than 50° C.) to cure the adhesive.

In contrast, two-part adhesives comprise two components. The first component, typically referred to as the “base resin component,” comprises the curable resin, e.g., a curable epoxy resin. The second component, typically referred to as the “accelerator component,” comprises the curing agent(s) and catalysts. Various other additives may be included in one or both components.

Epoxy resins function as a cross-linkable component in the structural adhesive. The term “epoxy resin” is used herein to mean any of monomeric, dimeric, oligomeric or polymeric epoxy materials containing at least one epoxy functional group per molecule. Such compounds include monomeric epoxy compounds and epoxides of the polymeric type and can be aliphatic, cycloaliphatic, aromatic or heterocyclic. Monomeric and oligomeric epoxy compounds have at least one and preferably one to four polymerizable epoxy groups per molecule. In polymeric type epoxides or epoxy resins, there may be many pendent epoxy groups (for example, a glycidyl methacrylate polymer could have several thousand pendent epoxy groups per average molecular weight).

The molecular weight of the epoxy resins may vary from low molecular weight monomeric or oligomeric epoxy resins with a molecular weight, for example, from about 100 g/mol to epoxy resins with a molecular weight of about 50,000 g/mol or more and may vary greatly in the nature of their backbone and substituent groups. For example, the backbone may be of any type, and substituent groups thereon can be any group not having a nucleophilic group or electrophilic group (such as an active hydrogen atom) which is reactive with an oxirane ring. Illustrative of permissible substituent groups are halogens, ester groups, ethers, sulfonate groups, siloxane groups, nitro groups, amide groups, nitrile groups, phosphate groups, etc. Mixtures of epoxy resins can also be used. In some embodiments, a structural adhesive comprises a mixture of two or more epoxy resins in order to modify and adapt the mechanical properties of the cross-linked structural adhesive with respect to specific requirements.

Types of epoxy resins that can be used include, for example, the reaction product of bisphenol A and epichlorohydrin, the reaction product of phenol and formaldehyde (novolac resin) and epichlorohydrin, peracid epoxies, glycidyl esters, glycidyl ethers, the reaction product of epichlorohydrin and p-amino phenol, the reaction product of epichlorohydrin and glyoxal tetraphenol and the like.

Epoxides that are particularly useful in the present invention are of the glycidyl ether type. Suitable glycidyl ether epoxides may include those in general formula (I):

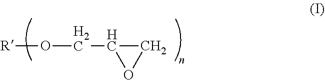

wherein R′ is alkyl, alkyl ether, or aryl; n is at least 1 and, in particular, in the range from 1 to 4. Suitable glycidyl ether epoxides of formula (I) include glycidyl ethers of Bisphenol A and F, aliphatic diols or cycloaliphatic diols. In some embodiments the glycidyl ether epoxides of formula (I) have a molecular weight in the range of from about 170 g/mol to about 10,000 g/mol. In other embodiments, the glycidyl ether epoxides of formula (I) have a molecular weight in the range of from about 200 g/mol to about 3,000 g/mol.

Useful glycidyl ether epoxides of formula (I) include linear polymeric epoxides having terminal epoxy groups (for example, a diglycidyl ether of polyoxyalkylene glycol) and aromatic glycidyl ethers (for example, those prepared by reacting a dihydric phenol with an excess of epichlorohydrin). Examples of useful dihydric phenols include resorcinol, catechol, hydroquinone, and the polynuclear phenols including p,p′-dihydroxydibenzyl, p,p′-dihydroxyphenylsulfone, p,p′-dihydroxybenzophenone, 2,2′-dihydroxyphenyl sulfone, p,p′-dihydroxybenzophenone, 2,2-dihydroxy-1,1-dinaphthylmethane, and the 2,2′, 2,3′, 2,4′, 3,3′, 3,4′, and 4,4′ isomers of dihydroxydiphenylmethane, dihydroxydiphenyldimethylmethane, dihydroxydiphenylethylmethylmethane, dihydroxydiphenylmethylpropylmethane, dihydroxydiphenylethylphenylmethane, dihydroxydiphenylpropylenphenylmethane, dihydroxydiphenylbutylphenylmethane, dihydroxydiphenyltolylethane, dihydroxydiphenyltolylmethylmethane, dihydroxydiphenyldicyclohexylmethane, and dihy droxy dipheny Icy clohexane. Suitable commercially available aromatic and aliphatic epoxides include diglycidylether of bisphenol A (for example, available under the tradename EPON 828, EPON 872, EPON 1001, EPON 1310 and EPONEX 1510 from Hexion Specialty Chemicals GmbH in Rosbach, Germany); DER-331, DER-332, and DER-334 (available from Dow Chemical Co. in Midland, MI); diglycidyl ether of bisphenol F (for example, EPICLON 830 available from Dainippon Ink and Chemicals, Inc.); PEGioooDGE (available from Polysciences, Inc. in Warrington, PA); silicone resins containing diglycidyl epoxy functionality; flame retardant epoxy resins (for example, DER 580, a brominated bisphenol type epoxy resin available from Dow Chemical Co. in Midland, MI); 1,4-dimethanol cyclohexyl diglycidyl ether; and 1,4-butanediol diglycidyl ether. Other epoxy resins based on bisphenols are commercially available under the tradenames D.E.N., EPALLOY and EPILOX. Additional useful resins can include, for example Erisys GA240, Araldite MY0500, and Araldite MY720 (all commercially available from Huntsman International, LLC Texas). In some embodiments, the structural adhesives of the present invention may comprise from about 20% to about 90% by weight epoxy resin. In other embodiments, the structural adhesives may comprise from about 40% to about 70% by weight epoxy resin. In yet other embodiments, the structural adhesives may comprise from about 40% to about 60% by weight epoxy resin.

Methods and articles included herein, wherein the adhesion promoter is a compound of formula I

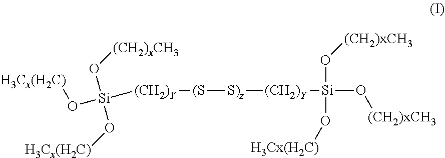

wherein x is an integer from 1 to 4, y is an integer from 2 to 6, and z is an integer from 1 to 6. Any compound of formula I can be used as an adhesion promoter within the structural adhesive composition. In some embodiments, a composition that includes compounds having different number of sulfurs can be utilized as adhesion promoters. In some embodiments, Bis[3-(triethoxysilyl) propyl] disulfide (commercially available under the trade designation “SIB 1824.6”, from Gelest, Inc, Morrisville, PA), Bis[3-(triethoxysilyl) propyl] tetrasulfide (commercially available under the trade designation “SIB 1825.0”, from Gelest, Inc, Morrisville, PA), or combinations thereof can be utilized.

In embodiments where the adhesion promoter is applied within the structural adhesive composition, the compound of formula I can be present in the adhesive composition in an amount from 0.1 wt % to 5 wt %. Although various structural adhesive compositions can be utilized, in some embodiments, useful structural adhesive compositions can include epoxy resins. In some embodiments, the adhesion promoter can be mixed with all components of the structural adhesive except for the catalyst and the accelerant, which can then be added after the composition has cooled.

The complete disclosures of the patents, patent documents, and publications cited herein are incorporated by reference in their entirety as if each were individually incorporated. To the extent that there is any conflict or discrepancy between this specification as written and the disclosure in any document that is incorporated by reference herein, this specification as written will control. Various modifications and alterations to this disclosure will become apparent to those skilled in the art without departing from the scope and spirit of this disclosure. It should be understood that this disclosure is not intended to be unduly limited by the illustrative embodiments and examples set forth herein and that such examples and embodiments are presented by way of example only with the scope of the disclosure intended to be limited only by the claims set forth herein as follows.

### Exemplary Aspects

Aspect 1 is an apparatus for dispensing adhesive, comprising: a housing body including a cavity; a housing front plate including an aperture sized to accommodate an outer surface of a selected male pipe, wherein housing front plate includes an angled surface; a channel for adhesive positioned to extrude adhesive between the angled surface and the outer surface of the selected male pipe.

Aspect 2 is the apparatus of Aspect 1 further including a pipe ejector member mounted inside the cavity, and wherein the pipe ejector is configured to hold an end of a selected pipe.

Aspect 3 is the apparatus of Aspect 2, wherein the housing cavity has an axis, and the angled surface is at an angle of between 5 and 85 degrees relative to the axis.

Aspect 4 is the apparatus of Aspect 3, wherein the pipe ejector member has an angled surface at an angle of between 5 and 85 degrees relative to the axis, and the angled surface of the pipe ejector member and the angled surface of the housing front plate are configured to substantially align.

Aspect 5 is the apparatus of Aspect 4, wherein the angled surfaces of the housing front plate and pipe ejector are both at an angle between 30 and 75 degrees relative to the axis of the housing body cavity.

Aspect 6 is the apparatus of Aspect 5, wherein the angled surfaces of the housing front plate and pipe ejector are both at an angle between 35 and 55 degrees relative to the axis of the main body cavity.

Aspect 7 is the apparatus of Aspect 1, further including an adhesive, wherein the adhesive is dispensed through the channel in a sleeve-like coating.

Aspect 8 is the apparatus of Aspect 7, wherein the sleeve-like coating of adhesive is a uniform shape axially and is substantially uniform in thickness.

Aspect 9 is the apparatus of Aspect 7, wherein the sleeve-like coating of adhesive has a tapered thickness having an axial diameter between 0.125 and 0.1875 inches and has a length of 0.25 to 0.75 inches.

Aspect 10 is a combination of the apparatus of Aspect 7 with a male pipe having an outer surface and a first planer end, wherein the sleeve-like coating of adhesive is on the outer surface of the male pipe.

Aspect 11 is the combination of Aspect 10, wherein the sleeve-like coating of adhesive is substantially not on the first planer end of the male pipe.

Aspect 12 is the combination of Aspect 10, wherein the sleeve-like coating of adhesive does not include substantial stringing between the male pipe and the apparatus.

Aspect 13 is the combination of Aspect 10, wherein the male pipe is first inserted into the aperture, and thereafter withdrawn from the aperture in a controlled linear movement to apply a tapered sleeve-like coating of adhesive on the outer surface of the male pipe.

Aspect 14 is the combination of Aspect 10, wherein the adhesive stops flowing through the aperture prior to withdrawal of the male pipe from the apparatus.

Aspect 15 is the combination of Aspect 10, wherein the apparatus further including a pipe ejector member mounted inside the cavity, wherein when the angled surfaces of the housing front plate and pipe ejector connect, the adhesive stops flowing and the pipe is positioned external of the apparatus.

Aspect 16 is the apparatus of Aspect 1, further including an adhesive, wherein the adhesive is dispensed through the channel and wherein the adhesive comprises a 1-part (1K) epoxy adhesive.

Aspect 17 is the apparatus of Aspect 1, further including an adhesive, wherein the adhesive is dispensed through the channel and wherein the adhesive comprises a 2-part (2K) epoxy adhesive.

Aspect 18 is the apparatus of Aspect 1, further including an adhesive, wherein the
adhesive is dispensed through the channel and wherein the adhesive comprises a structural adhesive composition comprising: a resin; and
an adhesion promoter, wherein the adhesion promoter is a compound of formula I

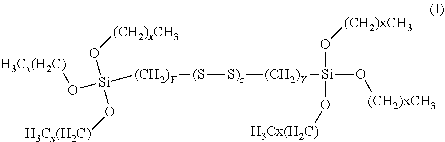

wherein x is an integer from 1 to 4, y is an integer from 2 to 6, and z is an integer from 1 to 6; and wherein the structural adhesive comprises from about 0.1 to 5 wt % of the adhesion promoter.

Aspect 19 is the apparatus of Aspect 18, wherein the resin comprises an epoxy resin.

Aspect 20 is the apparatus of Aspect 18 or 19, wherein the compound of formula I is Bis[3-(triethoxysilyl) propyl] disulfide.

Aspect 21 is the apparatus of Aspect 18 or 19, wherein the compound of formula I is Bis[3-(triethoxysilyl) propyl] tetrasulfide.

Aspect 22 is the apparatus of Aspect 18, wherein the structure adhesive composition comprises acrylic adhesive, 1K urethane adhesive, 2K urethane adhesive, or combinations thereof.

Aspect 23 is an apparatus for dispensing adhesive, comprising: a housing body including a cavity; a housing front plate including an aperture sized to accommodate an outer surface of a selected male pipe, wherein the housing front plate includes an angled surface; a channel for adhesive positioned to extrude adhesive between the angled surface and the outer surface of the selected male pipe; a location pin mounted inside the cavity, wherein the location pin is sized to accommodate an inner surface of the selected male pipe.

Aspect 24 is the apparatus of Aspect 23 further including a pipe ejector member mounted inside the cavity, wherein the pipe ejector is configured to hold an end of a selected pipe, and wherein the location pin is mounted on an end of the pipe ejector member.

Aspect 25 is the apparatus of Aspect 24, wherein the housing cavity has an axis, and the angled surface of the housing front plate is at an angle of between 5 and 85 degrees relative to the axis.

Aspect 26 is the apparatus of Aspect 25, wherein the pipe ejector member has an angled surface at an angle of between 5 and 85 degrees relative to the axis of the housing body cavity, and the angled surface of the pipe ejector member and the angled surface of the housing cavity are configured to substantially align.

Aspect 27 is the apparatus of Aspect 26, wherein the angled surfaces of the housing plate and location pin are both at an angle between 30 and 75 degrees relative to the axis of the housing body cavity.

Aspect 28 is the apparatus of Aspect 27, wherein the angled surfaces of the housing cavity and location pin are both at an angle between 35 and 55 degrees relative to the axis of the main body cavity.

Aspect 29 is the apparatus of Aspect 23, further including an adhesive, wherein the adhesive is dispensed through the aperture in a sleeve-like coating.

Aspect 30 is the apparatus of Aspect 29, wherein the sleeve-like coating of adhesive is a uniform shape axially and is substantially uniform in thickness.

Aspect 3 is the apparatus of Aspect 29, wherein the sleeve-like coating of adhesive has a tapered thickness having an axial diameter between 0.125 and 0.1875 inches and has a length of 0.25 to 0.75 inches.

Aspect 32 is a combination of the apparatus of Aspect 29 with a male pipe having an outer surface and a first planer end, wherein the sleeve-like coating of adhesive is on the outer surface of the male pipe.

Aspect 33 is the combination of Aspect 32, wherein the sleeve-like coating of adhesive is substantially not on the first planer end of the male pipe.

Aspect 34 is the combination of Aspect 32, wherein the sleeve-like coating of adhesive does not include substantial stringing between the male pipe and the apparatus.

Aspect 35 is the combination of Aspect 32, wherein the male pipe is first inserted into aperture of the apparatus, and thereafter withdrawn from the apparatus in a controlled linear movement to apply the sleeve-like coating of adhesive with a tapered thickness.

Aspect 36 is the combination of Aspect 32, wherein the adhesive stops flowing through the aperture prior to withdrawal of the male pipe from the apparatus.

Aspect 37 is the combination of Aspect 32, wherein the apparatus further including a pipe ejector member mounted inside the cavity, wherein the channel for adhesive is between the pipe ejector member, the housing body and the aperture, wherein the pipe ejector member has an angled surface, and when the angled surfaces of the housing front plate and the pipe ejector member connect, the adhesive stops flowing out of the aperture and the pipe is positioned external to the apparatus.

Aspect 38 is the apparatus of Aspect 23, further including an adhesive, wherein the adhesive is dispensed through the channel and wherein the adhesive comprises a 1-part (1K) epoxy adhesive.

Aspect 39 is the apparatus of Aspect 23, further including an adhesive, wherein the adhesive is dispensed through the channel and wherein the adhesive comprises a 2-part (2K) epoxy adhesive.

Aspect 40 is the apparatus of Aspect 23, further including an adhesive, wherein the adhesive is dispensed through the channel and wherein the adhesive comprises a structural adhesive composition comprising: a resin; and an adhesion promoter, wherein the adhesion promoter is a compound of formula I

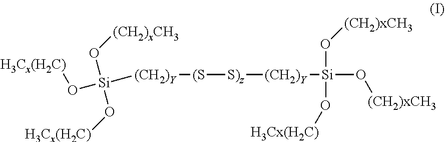

wherein x is an integer from 1 to 4, y is an integer from 2 to 6, and z is an integer from 1 to 6; and wherein the structural adhesive comprises from about 0.1 to 5 wt % of the adhesion promoter.

Aspect 41 is the apparatus of Aspect 40, wherein the resin comprises an epoxy resin.

Aspect 42 is the apparatus of Aspect 40 or 41, wherein the compound of formula I is Bis[3-(triethoxysilyl) propyl] disulfide.

Aspect 43 is the apparatus of Aspect 40 or 41, wherein the compound of formula I is Bis[3-(triethoxysilyl) propyl] tetrasulfide.

Aspect 44 is the apparatus of Aspect 40, wherein the structure adhesive composition comprises acrylic adhesive, 1K urethane adhesive, 2K urethane adhesive, or combinations thereof.

Aspect 45 is an apparatus for dispensing adhesive, comprising: a housing body including a cavity and an aperture, wherein the housing body includes an angled internal surface; a pipe ejector member mounted inside the cavity, wherein the pipe ejector member includes an angled surface; and wherein the pipe ejector member includes a depression for receiving an end of a selected male pipe; and a channel for adhesive positioned to extrude adhesive between the angled internal surface and the outer surface of the selected male pipe.

Aspect 46 is the apparatus of Aspect 45, wherein the housing cavity has an axis, and the angled internal surface is at an angle of between 5 and 85 degrees relative to the axis.

Aspect 47 is the apparatus of Aspect 46, wherein the angled surface of the pipe ejector member has an angle of between 5 and 85 degrees relative to the axis, and the angled surface of the pipe ejector member and the angled surface of the housing cavity are configured to substantially align.

Aspect 48 is the apparatus of Aspect 47, wherein the angled surfaces of the housing cavity and pipe ejector are both at an angle between 30 and 75 degrees relative to the axis of the housing body cavity.

Aspect 49 is the apparatus of Aspect 48, wherein the angled surfaces of the housing cavity and pipe ejector are both at an angle between 35 and 55 degrees relative to the axis of the main body cavity.

Aspect 50 is the apparatus of Aspect 45, further including an adhesive, wherein the adhesive is dispensed through the aperture in a sleeve-like coating.

Aspect 51 is the apparatus of Aspect 50, wherein the sleeve-like coating of adhesive is a uniform shape axially and is substantially uniform in thickness.

Aspect 52 is the apparatus of Aspect 50, wherein the sleeve-like coating of adhesive has a tapered thickness having an axial diameter between 0.125 and 0.1875 inches and has a length of 0.25 to 0.75 inches.

Aspect 53 is a combination of the apparatus of Aspect 50 with a male pipe having an outer surface and a first planer end, wherein the sleeve-like coating of adhesive is on the outer surface of the male pipe.

Aspect 54 is the combination of Aspect 53, wherein the sleeve-like coating of adhesive is substantially not on the first planer end of the male pipe.

Aspect 55 is the combination of Aspect 53, wherein the sleeve-like coating of adhesive does not include substantial stringing between the male pipe and the apparatus.

Aspect 56 is the combination of Aspect 53, wherein the male pipe is first inserted into the aperture, and thereafter withdrawn from the aperture in a controlled linear movement to apply the sleeve-like coating of adhesive with a tapered thickness.

Aspect 57 is the combination of Aspect 53, wherein the adhesive stops flowing through the aperture prior to withdrawal of the male pipe from the apparatus.

Aspect 58 is the combination of Aspect 53, wherein when the angled internal surfaces of the housing body and angled surface of the pipe ejector member connect, the adhesive stops flowing and the pipe is positioned external to the apparatus.

Aspect 59 is the apparatus of Aspect 45, further including an adhesive, wherein the adhesive is dispensed through the channel and wherein the adhesive comprises a 1-part (1K) epoxy adhesive.

Aspect 60 is the apparatus of Aspect 45, further including an adhesive, wherein the adhesive is dispensed through the channel and wherein the adhesive comprises a 2-part (2K) epoxy adhesive.

Aspect 61 is the apparatus of Aspect 45, further including an adhesive, wherein the adhesive is dispensed through the channel and wherein the adhesive comprises a structural adhesive composition comprising: a resin; and an adhesion promoter, wherein the adhesion promoter is a compound of formula I

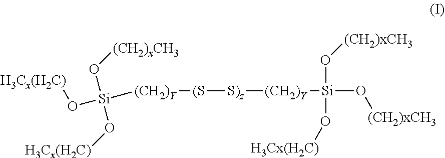

wherein x is an integer from 1 to 4, y is an integer from 2 to 6, and z is an integer from 1 to 6; and wherein the structural adhesive comprises from about 0.1 to 5 wt % of the adhesion promoter.

Aspect 63 is the apparatus of Aspect 61, wherein the resin comprises an epoxy resin.

Aspect 64 is the apparatus of Aspect 61 or 62, wherein the compound of formula I is Bis[3-(triethoxysilyl) propyl] disulfide.

Aspect 65 is the apparatus of Aspect 61 or 162, wherein the compound of formula I is Bis[3-(triethoxysilyl) propyl] tetrasulfide.

Aspect 66 is the apparatus of Aspect 61, wherein the structure adhesive composition comprises acrylic adhesive, 1K urethane adhesive, 2K urethane adhesive, or combinations thereof.

Aspect 67 is an apparatus for dispensing adhesive, comprising: housing body including a cavity and an aperture, wherein the housing body includes an angled internal surface; an internal member having an angled surface; a channel for adhesive positioned to extrude adhesive between the angled internal surface and the angled surface of the internal member onto the outer surface of the selected male pipe.

Aspect 68 is the apparatus of Aspect 67, wherein the housing cavity has an axis, and the internal angled surface of the housing body and the angled surface of the internal member is at an angle of between 5 and 85 degrees relative to the axis.

Aspect 69 is the apparatus of Aspect 68, wherein the housing cavity has an axis, and the internal angled surface of the housing body and the angled surface of the internal member is at an angle of between 30 and 75 degrees relative to the axis.

Aspect 70 is the apparatus of Aspect 69, wherein the housing cavity has an axis, and the internal angled surface of the housing body and the angled surface of the internal member is at an angle of between 35 and 55 degrees relative to the axis.

Aspect 71 is the apparatus of Aspect 67, further including an adhesive, wherein the adhesive is dispensed through the channel and out the aperture in a sleeve-like coating.

Aspect 72 is the apparatus of Aspect 71, wherein the sleeve-like coating of adhesive is a uniform shape axially and is substantially uniform in thickness.

Aspect 73 is the apparatus of Aspect 71, wherein the sleeve-like coating of adhesive has a tapered thickness having an axial diameter between 0.125 and 0.1875 inches and has a length of 0.25 to 0.75 inches.

Aspect 74 is a combination of the apparatus of Aspect 71 with a male pipe having an outer surface and a first planer end, wherein the sleeve-like coating of adhesive is on the outer surface of the male pipe.

Aspect 75 is the combination of Aspect 74, wherein the sleeve-like coating of adhesive is substantially not on the first planer end of the male pipe.

Aspect 76 is the combination of Aspect 74, wherein the sleeve-like coating of adhesive does not include substantial stringing between the male pipe and the apparatus.

Aspect 77 is the combination of Aspect 75, wherein the male pipe is first inserted into the aperture, and thereafter withdrawn from the aperture in a controlled linear movement to apply the sleeve-like coating of adhesive with a tapered thickness.

Aspect 78 is the combination of Aspect 75, wherein the adhesive stops flowing through the aperture prior to withdrawal of the male pipe from the apparatus.

Aspect 79 is the apparatus of Aspect 67, further including an adhesive, wherein the adhesive is dispensed through the channel and wherein the adhesive comprises a 1-part (1K) epoxy adhesive.

Aspect 78 is the apparatus of Aspect 67, further including an adhesive, wherein the adhesive is dispensed through the channel and wherein the adhesive comprises a 2-part (2K) epoxy adhesive.

Aspect 79 is the apparatus of Aspect 67, further including an adhesive, wherein the adhesive is dispensed through the channel and wherein the adhesive comprises a structural adhesive composition comprising: a resin; and
an adhesion promoter, wherein the adhesion promoter is a compound of formula I

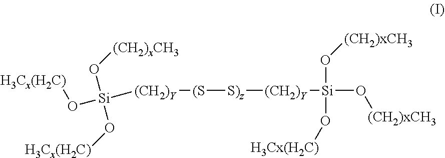

wherein x is an integer from 1 to 4, y is an integer from 2 to 6, and z is an integer from 1 to 6; and wherein the structural adhesive comprises from about 0.1 to 5 wt % of the adhesion promoter.

Aspect 80 is the apparatus of Aspect 79, wherein the resin comprises an epoxy resin.

Aspect 81 is the apparatus of Aspect 79 or 80, wherein the compound of formula I is Bis[3-(triethoxysilyl) propyl] disulfide.

Aspect 82 is the apparatus of Aspect 79 or 80, wherein the compound of formula I is Bis[3-(triethoxysilyl) propyl] tetrasulfide.

Aspect 83 is the apparatus of Aspect 79, wherein the structure adhesive composition comprises acrylic adhesive, 1K urethane adhesive, 2K urethane adhesive, or combinations thereof.

Aspect 84. A method of applying adhesive, comprising: providing an apparatus of Aspects 1, 23, 45, or 67; providing an adhesive to flow through the apparatus; providing a male pipe and a female pipe, wherein the male pipe comprises a first metal, and wherein the female pipe comprising a second metal; applying an adhesive composition to a male pipe; inserting at least a portion of the adhesive composition and the male pipe into the female pipe thereby forming an interface between the male pipe and the female pipe; and curing the adhesive composition to form an adhesive bond between the male pipe and the female pipe, wherein the cured adhesive composition limits corrosion of at least a portion of the male pipe, the female pipe, or both.

Aspect 85 is the method according to Aspect 84, wherein the adhesive composition comprises a 1 part (1K) epoxy adhesive.

Aspect 86 is the method according to Aspect 84, wherein the adhesive composition comprises a 2 part (2K) epoxy adhesive.

Aspect 87 is the method according to Aspect 84, wherein the adhesive composition comprises acrylic adhesive, 1K urethane adhesive, 2K urethane adhesive, or combinations thereof.

Aspect 88 is the method according to any of Aspects 84 to 87, wherein the first metal and the second metal are selected from copper (Cu), aluminum (Al), brass, or stainless steel.

Aspect 89 is the method according to any of Aspects 84 to 88, wherein the cured adhesive composition covers a portion of the external surface of the male element.

Aspect 90 is the method according to any of Aspects 84 to 89, wherein the cured adhesive composition covers a portion of the external surface of the female element.

Aspect 91 is the method according to any of the preceding Aspects, wherein the cured adhesive composition covers both a portion of the external surface of the male element and a portion of the external surface of the female element.

Aspect 92 is the method according to any of Aspects 84 to 91, wherein the step of curing occurs at temperatures above room temperature.

Aspect 93 is the method according to any of Aspects 84 to 91, wherein the step of curing occurs at room temperature.

1. An apparatus for dispensing adhesive, comprising:
a housing body including a cavity;
a housing front plate including an aperture sized to accommodate an outer surface of a selected male pipe, wherein housing front plate includes an angled surface;
a channel for adhesive positioned to extrude adhesive between the angled surface and the outer surface of the selected male pipe.

2. The apparatus of claim 1 further including a pipe ejector member mounted inside the cavity, and wherein the pipe ejector is configured to hold an end of a selected pipe.

3. The apparatus of claim 2, wherein the housing cavity has an axis, and the angled surface is at an angle of between 5 and 85 degrees relative to the axis.

4. The apparatus of claim 3, wherein the pipe ejector member has an angled surface at an angle of between 5 and 85 degrees relative to the axis, and the angled surface of the pipe ejector member and the angled surface of the housing front plate are configured to substantially align.

5. The apparatus of claim 4, wherein the angled surfaces of the housing front plate and pipe ejector are both at an angle between 30 and 75 degrees relative to the axis of the housing body cavity.

6. The apparatus of claim 5, wherein the angled surfaces of the housing front plate and pipe ejector are both at an angle between 35 and 55 degrees relative to the axis of the main body cavity.

7. The apparatus of claim 1, further including an adhesive, wherein the adhesive is dispensed through the channel in a sleeve-like coating.

8-22. (canceled)

23. An apparatus for dispensing adhesive, comprising:
a housing body including a cavity;
a housing front plate including an aperture sized to accommodate an outer surface of a selected male pipe, wherein the housing front plate includes an angled surface;
a channel for adhesive positioned to extrude adhesive between the angled surface and the outer surface of the selected male pipe;
a location pin mounted inside the cavity, wherein the location pin is sized to accommodate an inner surface of the selected male pipe.

24. The apparatus of claim 23 further including a pipe ejector member mounted inside the cavity, wherein the pipe ejector is configured to hold an end of a selected pipe, and wherein the location pin is mounted on an end of the pipe ejector member.

25. The apparatus of claim 24, wherein the housing cavity has an axis, and the angled surface of the housing front plate is at an angle of between 5 and 85 degrees relative to the axis.

26. The apparatus of claim 25, wherein the pipe ejector member has an angled surface at an angle of between 5 and 85 degrees relative to the axis of the housing body cavity, and the angled surface of the pipe ejector member and the angled surface of the housing cavity are configured to substantially align.

27. The apparatus of claim 26, wherein the angled surfaces of the housing plate and location pin are both at an angle between 30 and 75 degrees relative to the axis of the housing body cavity.

28. The apparatus of claim 27, wherein the angled surfaces of the housing cavity and location pin are both at an angle between 35 and 55 degrees relative to the axis of the main body cavity.

29. The apparatus of claim 23, further including an adhesive, wherein the adhesive is dispensed through the aperture in a sleeve-like coating.

30-44. (canceled)

45. An apparatus for dispensing adhesive, comprising:
a housing body including a cavity and an aperture, wherein the housing body includes an angled internal surface;
a pipe ejector member mounted inside the cavity, wherein the pipe ejector member includes an angled surface; and wherein the pipe ejector member includes a depression for receiving an end of a selected male pipe; and
a channel for adhesive positioned to extrude adhesive between the angled internal surface and the outer surface of the selected male pipe.

46. The apparatus of claim 45, wherein the housing cavity has an axis, and the angled internal surface is at an angle of between 5 and 85 degrees relative to the axis.

47. The apparatus of claim 46, wherein the angled surface of the pipe ejector member has an angle of between 5 and 85 degrees relative to the axis, and the angled surface of the pipe ejector member and the angled surface of the housing cavity are configured to substantially align.

48. The apparatus of claim 47, wherein the angled surfaces of the housing cavity and pipe ejector are both at an angle between 30 and 75 degrees relative to the axis of the housing body cavity.

49. The apparatus of claim 48, wherein the angled surfaces of the housing cavity and pipe ejector are both at an angle between 35 and 55 degrees relative to the axis of the main body cavity.

50. The apparatus of claim 45, further including an adhesive, wherein the adhesive is dispensed through the aperture in a sleeve-like coating.

51-66. (canceled)

67. An apparatus for dispensing adhesive, comprising:
a housing body including a cavity and an aperture, wherein the housing body includes an angled internal surface;
an internal member having an angled surface;
a channel for adhesive positioned to extrude adhesive between the angled internal surface and the angled surface of the internal member onto the outer surface of the selected male pipe.

68. The apparatus of claim 67, wherein the housing cavity has an axis, and the internal angled surface of the housing body and the angled surface of the internal member is at an angle of between 5 and 85 degrees relative to the axis.

69. The apparatus of claim 68, wherein the housing cavity has an axis, and the internal angled surface of the housing body and the angled surface of the internal member is at an angle of between 30 and 75 degrees relative to the axis.

70. The apparatus of claim 69, wherein the housing cavity has an axis, and the internal angled surface of the housing body and the angled surface of the internal member is at an angle of between 35 and 55 degrees relative to the axis.

71. The apparatus of claim 67, further including an adhesive, wherein the adhesive is dispensed through the channel and out the aperture in a sleeve-like coating.

72-93. (canceled)
